(19) United States
(12) Patent Application Publication
(10) Pub. No.: US 2005/0218574 A1
(43) Pub. Date: Oct. 6, 2005

(54) Hydraulic shock absorber

(76) Inventor: Makoto Nishimura, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/090,056

(22) Filed: Mar. 28, 2005

(30) Foreign Application Priority Data
Mar. 31, 2004 (JP) 105185/2004

(51) Int. Cl. F16F 7/00

(52) U.S. Cl. 267/220

(57) ABSTRACT

In a non-slide region for a piston in a cylinder, four projections are arranged in a circumferential direction of the cylinder. Two rows of projections, each including four projections, are arranged so as to be spaced apart from each other in an axial direction of the cylinder. An annular spring seat is press-fitted around projecting ends of the projections, with a stepped portion of the spring seat abutting against the projections, to thereby fix the spring seat to the cylinder. With this arrangement, the spring seat can be attached to the cylinder without being welded. By arranging a plurality of projections in a circumferential direction of the cylinder, deformation of the cylinder due to formation of the projections can be limited. By forming the projections in two rows that are spaced apart from each other in an axial direction of the cylinder, a moment load applied to the spring seat can be efficiently supported. Thus, in a hydraulic shock absorber of the present invention, a spring seat is secured to a cylinder without any need for welding, and deformation of the cylinder can be minimized.

### BACKGROUND OF THE INVENTION

The present invention relates to a hydraulic shock absorber having a spring seat mounted thereon.

As an example of a hydraulic shock absorber which is applied to a suspension apparatus for an automobile, there is known a hydraulic shock absorber in which a spring seat for receiving a suspension spring is mounted on an outer circumferential surface of a cylinder portion. Conventionally, in a hydraulic shock absorber of this type, to secure a spring seat to a cylinder portion, the spring seat is directly welded to an outer circumferential surface of the cylinder portion. However, direct welding of a spring seat to a cylinder portion gives rise to problems such as contamination and thermal deformation of the cylinder portion. In the case of a monotube type hydraulic shock absorber, where a spring seat is directly welded to an outer circumferential surface of a cylinder in which a piston slidably moves, the problems referred to above become significant.

With a view to solving such problems, Japanese Utility Model Application Examined Publication No. SHO 55-12608 proposes a hydraulic shock absorber in which a spring seat that has a substantially bell-like configuration is used; wherein one end of the spring seat is press-fitted around an outer circumferential surface of a cylinder portion and the other end of the spring seat is fitted over the end of the cylinder portion through which a piston rod extends.

Further, Japanese Patent Application Public Disclosure No. HEI 7-280018 discloses a technique in which an opening is formed in a spring seat, and a projection is formed in an outer circumferential surface of a cylinder portion; and the opening and the projection are rotated relative to each other for engagement, to thereby secure the spring seat to the cylinder portion. By using this arrangement, the spring seat can be secured to the cylinder portion without the need for welding.

However, the techniques disclosed in the above patent documents are subject to the following problems. In Japanese Utility Model Application Examined Publication No. SHO 55-12608, the spring seat extends between the end of the cylinder portion through which the piston rod extends and a spring-receiving portion of the cylinder portion for receiving a suspension spring. This increases both a size and a weight of the component of the apparatus. In Japanese Patent Application Public Disclosure No. HEI 7-280018, the form of both the projection and the opening for engagement is complicated, which necessitates a difficult forming operation to be carried out. Further, when this technique is applied to a monotube type hydraulic shock absorber, a problem of deformation of the cylinder portion arises.

### SUMMARY OF THE INVENTION

The present invention has been made to overcome the problems of the arts described above. It is an object of the present invention to provide a hydraulic shock absorber in which a spring seat is secured to a cylinder portion without any need for welding, and deformation of the cylinder portion is minimized.

In order to achieve the stated object, the present invention provides a hydraulic shock absorber comprising:
a cylinder portion in which a piston rod is provided, the piston rod projecting from the cylinder portion,
the cylinder portion including at least one locking portion formed in an outer circumferential surface thereof,
the at least one locking portion including either a single projection formed in the outer circumferential surface of the cylinder portion or a plurality of projections formed in the outer circumferential surface, the plurality of projections being arranged in a circumferential direction of the cylinder portion; and
an annular spring seat press-fitted around a projecting end of the at least one locking portion.

The present invention also provides a method of manufacture for forming projections in a cylinder portion, comprising the steps of:
providing a cylinder portion;
providing die portions including recesses around a periphery of the cylinder portion;
inserting pressure-applying pieces into the cylinder portion, the pressure-applying pieces including punch portions in the form of projections;
inserting a wedge-like mandrel between the pressure-applying pieces, to thereby move the pressure-applying pieces in a radially outward direction for opening, and performing shear deformation so that a side wall of the cylinder portion is pressed into the die portions by means of the punch portions, to thereby form projections in the cylinder portion.

The present invention further provides a forming apparatus for forming projections in a cylinder portion, comprising:
pressure-applying pieces adapted to be inserted into the cylinder portion, the pressure-applying pieces including punch portions in the form of projections, the punch portions being adapted to press the cylinder portion outward so as to form projections in the cylinder portion;
a wedge-like mandrel adapted to be inserted between the pressure-applying pieces;
a pressure-applying pieces support device for supporting the pressure-applying pieces in such a manner as to allow radial movement thereof in the cylinder portion;
a pressing device for returning the pressure-applying pieces and the mandrel to initial positions; and
die portions including recesses, which are fitted around the cylinder portion and which enable the projections formed by the punch portions of the pressure-applying pieces to have predetermined configurations.

### BRIEF DESCRIPTION OF THE DRAWINGS

FIG. 1 is a vertical sectional view of a hydraulic shock absorber according to a first embodiment of the present invention.

FIG. 2 is an enlarged view of an essential part of the apparatus of FIG. 1, i.e., a structure for mounting a spring seat.

FIG. 3 is a vertical sectional view of a bottom portion of a hydraulic shock absorber as a modified example of the embodiment shown in FIG. 1.

FIG. 4A is a diagram indicating how a projection is formed in a cylinder of the hydraulic shock absorber of FIG. 1.

FIG. 4B is a diagram indicating how the projection is formed in the cylinder of the hydraulic shock absorber of FIG. 1.

FIG. 5A is a diagram indicating how the spring seat is press-fitted around the cylinder of the hydraulic shock absorber of FIG. 1.

FIG. 5B is a diagram indicating how the spring seat is press-fitted around the cylinder of the hydraulic shock absorber of FIG. 1.

FIG. 6 is a vertical sectional view of a hydraulic shock absorber as a modified example of the embodiment of FIG. 1.

FIG. 7 is a vertical sectional view of a part of a hydraulic shock absorber according to a second embodiment of the present invention.

### DETAILED DESCRIPTION OF THE INVENTION

Hereinbelow, an embodiment of the present invention will be described with reference to the accompanying drawings.

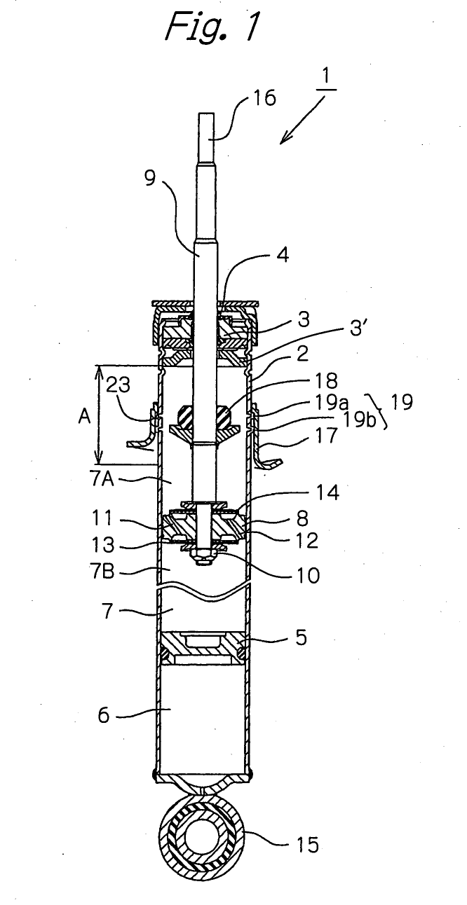

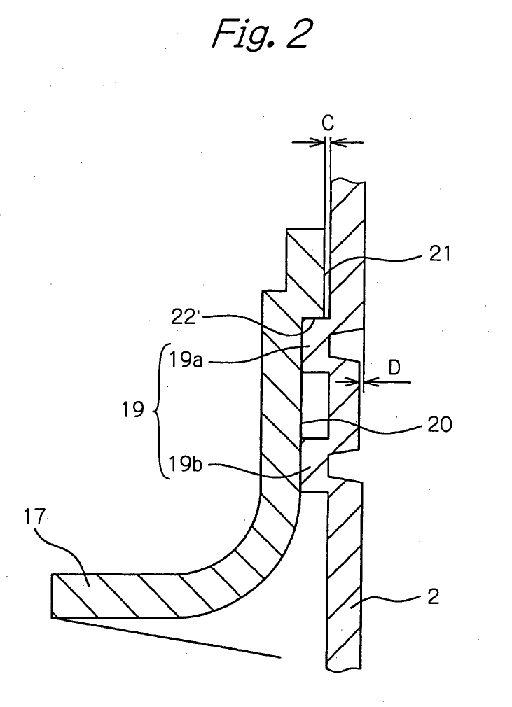

As indicated in FIGS. 1 and 2, a hydraulic shock absorber 1 according to a first embodiment of the present invention is a monotube type hydraulic shock absorber comprising a cylinder 2 having one end closed (a cylinder portion). A rod guide 3 and an oil seal 4 are attached to an open end of the cylinder 2. A free piston 5 is slidably fitted into the cylinder 2 on a side of the closed end thereof. An inside of the cylinder 2 is divided into a gas chamber 6, located on a side of the closed end of the cylinder 2, and a hydraulic fluid chamber 7, located on a side of the open end of the cylinder 2. A high-pressure gas and a hydraulic fluid are sealably contained in the gas chamber 6 and the hydraulic fluid chamber 7, respectively.

A piston 8 is slidably fitted into the hydraulic fluid chamber 7 of the cylinder 2. The inside of the hydraulic fluid chamber 7 is divided into two chambers, namely, an upper cylinder chamber 7A and a lower cylinder chamber 7B, by means of the piston 8. One end of a piston rod 9 is connected to the piston 8 by means of a nut 10. The other end of the piston rod 9 is slidably and liquid-tightly inserted through the rod guide 3 and the oil seal 4, and extends to the outside of the cylinder 2.

An extension-stroke hydraulic fluid passage 11 and a compression-stroke hydraulic fluid passage 12 for communication between the upper cylinder chamber 7A and the lower cylinder chamber 7B are formed in the piston 8. The extension-stroke hydraulic fluid passage 11 and the compression-stroke hydraulic fluid passage 12 are provided with an extension-stroke damping force generation mechanism 13 and a compression-stroke damping force generation mechanism 14, respectively. Each of the extension-stroke damping force generation mechanism 13 and the compression-stroke damping force generation mechanism 14 comprises an orifice, a disk valve, etc., for generating a damping force by controlling a flow of the hydraulic fluid.

By these arrangements, during an extension stroke of the piston rod 9, according to a slidable movement of the piston 8 in the cylinder 2, the hydraulic fluid in the upper cylinder chamber 7A flows into the lower cylinder chamber 7B through the extension-stroke hydraulic fluid passage 11 formed in the piston 8, and a damping force is generated by the extension-stroke damping force generation mechanism 13. During a compression stroke of the piston rod 9, the hydraulic fluid in the lower cylinder chamber 7B flows into the upper cylinder chamber 7A through the compression-stroke hydraulic fluid passage 12, and a damping force is generated by the compression-stroke damping force generation mechanism 14. During the extension and compression strokes, a change in volume of the hydraulic fluid chamber 7 caused by a portion of the piston rod 9 moving into or out of the cylinder 2 is compensated for by the movement of the free piston 5, which causes compression or expansion of the high-pressure gas in the gas chamber 6.

A mount eye 15 for connection with a suspension arm or the like (not shown) is connected to the closed end of the cylinder 2. A mount portion 16 for connection to a vehicle body is formed at a forward end portion of the piston rod 9. A spring seat 17 for receiving a suspension spring (not shown) interposed between the cylinder 2 and the vehicle body is attached to an outer circumferential surface of an upper end portion of the cylinder 2. A rebound stopper 18 is attached to the piston rod 9 in the cylinder 2. The rebound stopper 18 is made of an elastic material capable of absorbing an impact, such as rubber.

Next, description is made with regard to a structure for mounting the spring seat 17 on the cylinder 2.

In the hydraulic shock absorber 1, an extension stroke of the piston rod 9 is limited by means of the rebound stopper 18. Therefore, a slide region for the piston 8 in the cylinder 2 is limited, and an upper portion of the cylinder 2 includes a non-slide region A in which no sliding of the piston 8 occurs. That is, when the piston rod 9 moves upward as viewed in FIG. 1, the rebound stopper 18 abuts against a washer 3′ disposed below the rod guide 3, thus preventing entry of the piston 8 into the non-slide region A.

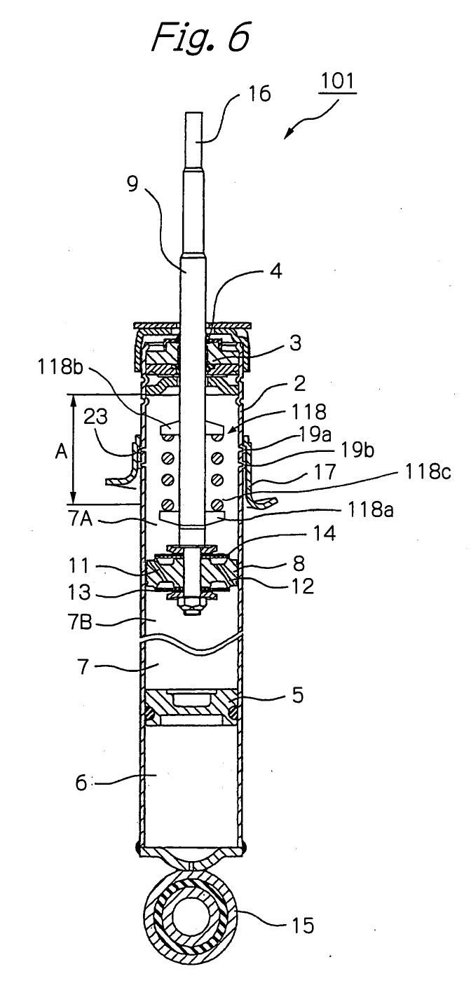

As indicated in FIG. 6, the rebound stopper 18 may be replaced by a rebound spring 118. The rebound spring 118 comprises a lower-side receiving portion 118a secured to the piston rod 9, an upper-side receiving portion 118b slidably provided along the piston rod 9 and a spring 118c interposed between the lower-side receiving portion 118a and the upper-side receiving portion 118b. The spring 118c biases the upper-side receiving portion 118b in a direction of the extension stroke of the piston rod 9. That is, the upper-side receiving portion 118b is always biased towards the washer 3′ disposed below the rod guide 3, by means of the spring 118c. When the piston rod 9 moves upward as viewed in FIG. 6, the rebound spring 118 abuts against the washer 3′ and, due to a reaction force of the rebound spring 118, the piston 8 cannot enter the non-slide region A.

The cylinder 2 includes a locking device 19 formed at a portion thereof corresponding to the non-slide region A and extending in a circumferential direction of the cylinder 2. The locking device 19 comprises a first locking portion and a second locking portion. The first locking portion comprises four projections 19a arranged in the circumferential direction of the cylinder 2, and the second locking portion comprises four projections 19b arranged in the circumferential direction of the cylinder 2. Thus, the projections 19a and the projections 19b of the first and second locking portions are arranged in two rows that are spaced apart from each other by a predetermined distance in an axial direction of the cylinder 2. The locking device 19 may comprise a single locking portion. In this case, the single locking portion may comprise at least one projection.

The cylinder 2 between the projections 19a and the projections 19b, which are formed in two rows that are axially spaced apart from each other, has an inner diameter larger than that of the cylinder 2 in the slide region for the piston 8 (see a distance D in FIG. 2). An upper end portion of the spring seat 17 is reduced in diameter, to thereby form a large-diameter portion 20 and a small-diameter portion 21, with a stepped portion 22 being formed therebetween. A projecting end of the projection 19a is press-fitted into the large-diameter portion 20 of the spring seat 17, with an upper side of the projection 19a abutting against the stepped portion 22, thus securing the spring seat 17 to the cylinder 2. Thus, as indicated in FIG. 2, the projections 19a and 19b are press-fitted into the large-diameter portion 20 of the spring seat 17. In contrast, the cylinder 2 is loosely fitted into the small-diameter portion 21 of the spring seat 17 having a minimum inner diameter, thus forming a clearance C between an outer circumferential surface of the cylinder 2 and the small-diameter portion 21.

For enabling a high load acting on the spring seat 17 to be supported by the projections 19a and 19b, it is preferable for angular portions of the projecting ends of the projections 19a and 19b to be sufficiently projected and an angular portion of a recess formed by the stepped portion 22 to be sufficiently recessed.

An operation of the first embodiment is described below.

The spring seat 17 is secured to the cylinder 2 by press-fitting the projecting ends of the projections 19a and 19b into the large-diameter portion 20 while abutting the projections 19a against the stepped portion 22. Since the projections 19a and 19b are located at the non-slide region A, sealability of the piston 8 is not impaired. Since a plurality of projections 19a or 19b is arranged in a circumferential direction of the cylinder 2, as compared to the case of a single projection being formed so as to extend all the way around a periphery of the cylinder 2, the cylinder 2 is subject to less strain when the projections 19a and 19b are formed by plastic deformation. Therefore, even in the monotube type hydraulic shock absorber in which the piston 8 directly slides in the cylinder 2, sealability of the piston 8 is not lowered due to deformation of the cylinder 2. Since the projections 19a and 19b are arranged in two rows which are axially spaced apart from each other, a moment load applied to the spring seat 17 can be efficiently supported. An inner diameter of the cylinder 2 between the projections 19a and the projections 19b, which are formed in two rows that are axially spaced apart from each other, is larger than that of the cylinder 2 at the slide region for the piston 8, by a distance D. Therefore, when the free piston 5 and the piston 8 are fitted into the cylinder 2, seal portions of the free piston 5 and the piston 8 are unlikely to be damaged. By sufficiently projecting angular portions of the projecting ends of the projections 19a and 19b and sufficiently recessing an angular portion of a recess formed by the stepped portion 22, a load acting on the spring seat 17 and capable of being supported by the projections 19a and 19b can be increased, and a fixing strength of the spring seat 17 with respect to an axial direction can be increased. The small-diameter portion 21 of the spring seat 17 is loosely fitted around an outer circumferential surface of the cylinder 2, with a clearance C being formed therebetween. Therefore, when fitting the spring seat 17 around the cylinder 2, the small-diameter portion 21 does not interfere with the outer circumferential surface of the cylinder 2, thus eliminating any risk of damaging a finished surface of the cylinder 2.

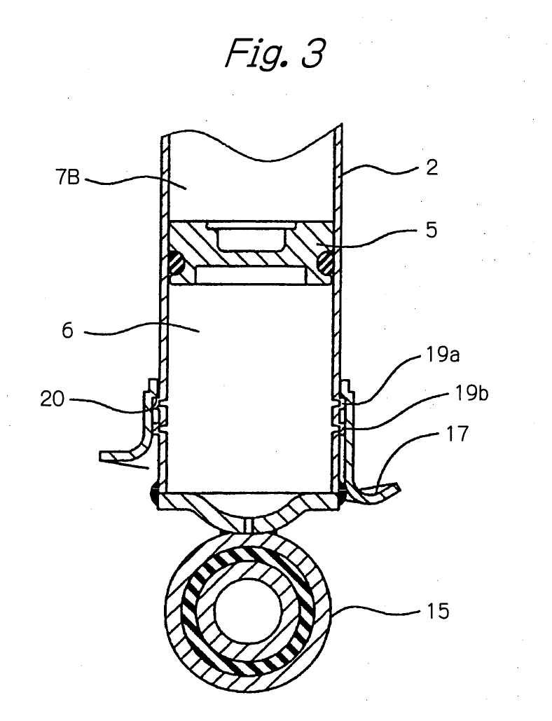

In the first embodiment, the projections 19a and 19b are arranged in two rows that are axially spaced apart from each other, each of the two rows including four projections arranged in a circumferential direction of the cylinder 2. However, this does not limit the present invention. Two or more projections may be arranged in the circumferential direction, and the projections may be arranged in three or more rows that are axially spaced apart from each other. Even a single row of projections is capable of supporting a moment load applied to the spring seat 17 when an axial dimension of the projecting ends of the projections is increased. The position of the spring seat 17 on the cylinder 2 is not particularly limited, as long as the projections 19a and 19b are located at the non-slide region for the piston 8 and the free piston 5 in the cylinder 2. For example, as indicated in FIG. 3, the spring seat 17 may be attached to the cylinder 2 at a position in the vicinity of the closed end thereof. Further, in the first embodiment, the spring seat 17 is attached to the cylinder 2 of the monotube type hydraulic shock absorber 1. However, by forming the projections 19a and 19b in an outer circumferential surface of a cylinder portion of a hydraulic shock absorber, the spring seat 17 can be attached to a twin-tube type hydraulic shock absorber comprising an inner cylinder and an outer cylinder, a suspension strut, etc.

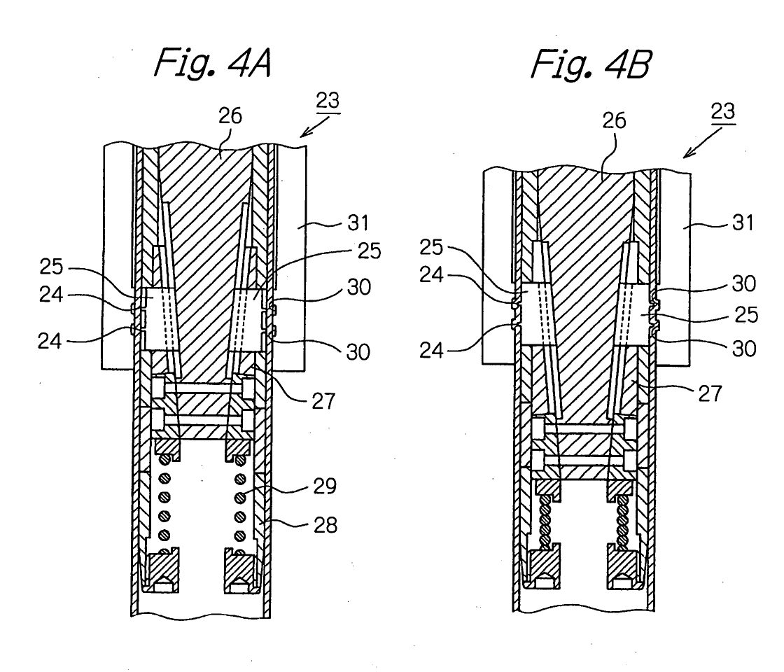

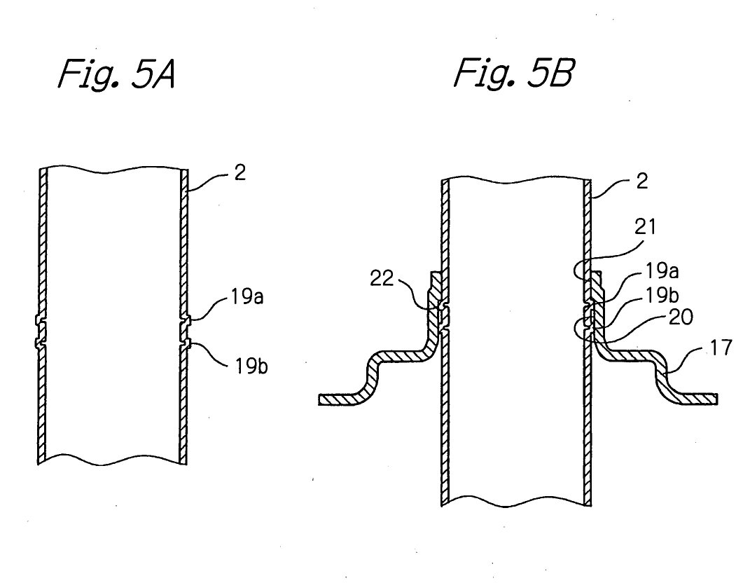

Next, description is made with regard to a method for mounting the spring seat 17 on the cylinder 2, referring to FIGS. 4A, 4B, 5A and 5B.

As indicated in FIG. 4A, a forming apparatus 23 for forming the projections 19a and 19b in the cylinder 2 comprises pressure-applying pieces 25 (inner molds) to be inserted into the cylinder 2. Each pressure-applying piece 25 has punch portions 24 in the form of projections for pressing the cylinder 2 outward to form the projections 19a and 19b. The forming apparatus 23 further comprises a wedge-like mandrel 26 to be inserted between the pressure-applying pieces 25, a pressure-applying piece retainer 27 and a pressure-applying piece guide 28 for supporting the pressure-applying pieces 25 in the cylinder 2 in such a manner as to allow radial movement of the pressure-applying pieces 25, a return spring 29 for returning the pressure-applying pieces 25 and the mandrel 26 to their initial positions, and an outer mold 31. The outer mold 31 comprises separable parts, and is fitted around the cylinder 2. The outer mold 31 includes die portions 30 for enabling the projections 19a and 19b formed by the punch portions 24 of the pressure-applying pieces 25 to have predetermined configurations.

As shown in FIG. 4B, the pressure-applying pieces 25 and the outer mold 31 are positioned, and the mandrel 26 is inserted between the pressure-applying pieces 25. The pressure-applying pieces 25 are moved radially outward for opening. In this instance, by means of the punch portions 24, a side wall of the cylinder 2 is pressed into the die portions 30 of the outer mold 31, thus performing shear deformation to form the projections 19a and 19b. Thus, to form the projections 19a and 19b, deformation of the side wall of the cylinder 2 is limited by the punch portions 24 of the pressure-applying pieces 25 and the die portions 30 of the outer mold 31, so that the projections 19a and 19b can be dimensioned highly accurately. After forming the projections 19a and 19b, the mandrel 26 and the pressure-applying pieces 25 are returned under a force of the return spring 29. The outer mold 31 is opened, and the cylinder 2 having the projections 19a and 19b formed therein is removed from the outer mold 31.

The cylinder 2 thus obtained has the projections 19a and 19b formed therein, as shown in FIG. 5A. Then, the spring seat 17 is press-fitted around the cylinder 2 as indicated in FIG. 5B.

Thus, in the hydraulic shock absorber according to this embodiment, the spring seat can be secured to the cylinder portion by press-fitting the projecting ends of one or more projections formed in the cylinder portion into the spring seat. By this arrangement, problems associated with welding, such as deformation of the cylinder portion, can be eliminated.

Since the projections are disposed at the non-slide region for the piston and the free piston, a problem of sealability of the piston and the free piston being lowered due to the projections does not occur.

Further, by means of the projections arranged in two or more rows, a moment load applied to the spring seat can be effectively supported.

Further, the cylinder between the projections disposed in an axially spaced relationship has an inner diameter larger than that of the cylinder in the slide region for the piston. Therefore, when fitting the piston into the cylinder, a seal portion of the piston is unlikely to be damaged.

Further, a minimum inner diameter of the spring seat is made larger than an outer diameter of the cylinder. Therefore, when fitting the spring seat around the cylinder, the spring seat does not interfere with an outer circumferential surface of the cylinder, thus eliminating any risk of damage to the surface of the cylinder.

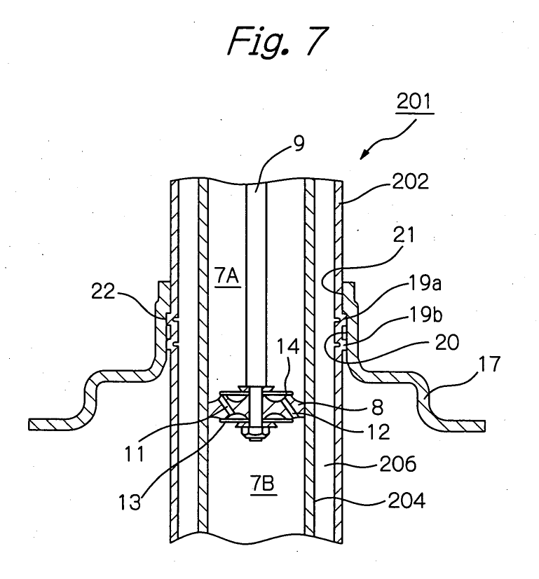

Next, referring to FIG. 7, description is made with regard to a second embodiment of the present invention. In FIG. 7 and the following explanation, those portions which are the same as or correspond to those in the first embodiment are designated by the same reference numerals as used in the first embodiment, and overlapping explanation is omitted.

The hydraulic shock absorber 1 in the first embodiment is a monotube type. A hydraulic shock absorber 201 in the second embodiment is a twin-tube type.

The twin-tube type hydraulic shock absorber 201 comprises an outer cylinder 202 and an inner cylinder 204 provided inside the outer cylinder 202. A reservoir 206 is formed between the outer cylinder 202 and the inner cylinder 204. A piston 8 is slidably fitted into the inner cylinder 204. By means of the piston 8, an inside of the inner cylinder 204 is divided into two chambers, namely, an upper cylinder chamber 7A and a lower cylinder chamber 7B.

The outer cylinder 202 includes a plurality of projections 19a and 19b arranged in a circumferential direction thereof. Specifically, four projections 19a are arranged in the circumferential direction of the outer cylinder 202, and four projections 19b are arranged in the circumferential direction of the outer cylinder 202. The projections 19a and the projections 19b are arranged in two rows that are spaced apart from each other in an axial direction of the outer cylinder 202. An upper end portion of a spring seat 17 is reduced in diameter, to thereby form a large-diameter portion 20 and a small-diameter portion 21, with a stepped portion 22 being formed therebetween. Projecting ends of the projections 19a and 19b of the outer cylinder 202 are press-fitted into the large-diameter portion 20 of the spring seat 17, with an upper side of the projections 19a abutting against the stepped portion 22, thus fixing the spring seat 17 to the outer cylinder 202.

By these arrangements, even in the twin-tube type hydraulic shock absorber, the spring seat 17 can be fixed to the outer cylinder 202 without being welded. In the second embodiment in which the spring seat 17 is fixed to the outer cylinder 202, the spring seat 17 can be fixed to a desired position on the outer cylinder 202, without taking into consideration a range of a stroke of the piston 8. In a hydraulic shock absorber according to this embodiment, a spring seat can be fixed to a cylinder portion while avoiding any problem associated with welding, such as deformation of the cylinder portion.

Although only some exemplary embodiments of this invention have been described in detail above, those skilled in the art will readily appreciate that many modifications are possible in the exemplary embodiments without materially departing from the novel teaching and advantages of this invention. Accordingly, all such modifications are intended to be included within the scope of this invention.

The entire disclosure of Japanese Patent Application No. 2004-105185 filed on Mar. 31, 2004 including specification, claims, drawings and summary is incorporated herein by reference in its entirety.

1. A hydraulic shock absorber comprising:
a cylinder portion in which a piston rod is provided, the piston rod projecting from the cylinder portion,
the cylinder portion including at least one locking portion formed in an outer circumferential surface thereof,
the at least one locking portion including either one of a single projection formed in the outer circumferential surface of the cylinder portion and a plurality of projections formed in the outer circumferential surface, the plurality of projections being arranged in a circumferential direction of the cylinder portion; and
an annular spring seat press-fitted around a projecting end of the at least one locking portion.

2. A hydraulic shock absorber according to claim 1, wherein the cylinder portion comprises a cylinder of a monotube type hydraulic shock absorber into which a piston and a free piston are slidably fitted, and the at least one locking portion is formed at a portion of the cylinder corresponding to a non-slide region for the piston and the free piston.

3. A hydraulic shock absorber according to claim 1, wherein the plurality of projections are formed in two or more rows arranged in an axial direction of the cylinder portion.

4. A hydraulic shock absorber according to claim 3, wherein an inner diameter of the cylinder portion between the projections arranged in the axial direction is larger than an inner diameter of the cylinder portion in a slide region for the piston.

5. A hydraulic shock absorber according to claim 1, wherein a minimum inner diameter of the spring seat is larger than an outer diameter of the cylinder portion.

6. A hydraulic shock absorber according to claim 2, wherein the at least one locking portion is formed in the cylinder portion at a position in the vicinity of a closed end thereof.

7. A hydraulic shock absorber according to claim 2, wherein a rebound stopper for limiting an extension stroke of the piston rod is attached to the piston rod in the cylinder portion, to thereby limit a slide region for the piston in the cylinder portion, and to form the non-slide region for the piston in a predetermined portion of the cylinder portion.

8. A hydraulic shock absorber according to claim 7, wherein the rebound stopper is made of an elastic member capable of absorbing an impact.

9. A hydraulic shock absorber according to claim 7, wherein the rebound stopper includes a lower-side receiving portion fixed to the piston rod, an upper-side receiving portion slidably provided along the piston rod and a spring provided between the lower-side receiving portion and the upper-side receiving portion, the spring being adapted to bias the upper-side receiving portion in a direction of the extension stroke of the piston rod.

10. A hydraulic shock absorber according to claim 1, wherein the cylinder portion comprises an outer cylinder of a twin-tube type hydraulic shock absorber.

11. A hydraulic shock absorber according to claim 10, wherein the plurality of projections are formed in two or more rows arranged in an axial direction of the cylinder portion.

12. A hydraulic shock absorber according to claim 11, wherein an inner diameter of the cylinder portion between the projections arranged in the axial direction is larger than an inner diameter of the cylinder portion in a slide region for the piston.

13. A hydraulic shock absorber according to claim 10, wherein a minimum inner diameter of the spring seat is larger than an outer diameter of the cylinder portion.

14. A method of manufacture for forming projections in a cylinder portion, comprising the steps of:
providing a cylinder portion;
providing die portions including recesses around a periphery of the cylinder portion;
inserting pressure-applying pieces into the cylinder portion, the pressure-applying pieces including punch portions in the form of projections;
inserting a wedge-like mandrel between the pressure-applying pieces, to thereby move the pressure-applying pieces in a radially outward direction for opening, and
performing shear deformation so that a side wall of the cylinder portion is pressed into the die portions by means of the punch portions, to thereby form projections in the cylinder portion.

15. A method of manufacture according to claim 14, further comprising a step of press-fitting a spring seat around the cylinder portion in which the projections have been formed.

16. A forming apparatus for forming projections in a cylinder portion, comprising:
pressure-applying pieces adapted to be inserted into a cylinder portion, the pressure-applying pieces including punch portions in the form of projections, the punch portions being adapted to press the cylinder portion outward so as to form projections in the cylinder portion;
a wedge-like mandrel adapted to be inserted between the pressure-applying pieces;
a pressure-applying pieces support device for supporting the pressure-applying pieces in such a manner as to allow radial movement thereof in the cylinder portion;
a pressing device for returning the pressure-applying pieces and the mandrel to initial positions; and
die portions including recesses, which are fitted around the cylinder portion and which enable the projections formed by the punch portions of the pressure-applying pieces to have predetermined configurations.
